(19) United States
(12) Patent Application Publication
(10) Pub. No.: US 2026/0330680 A1
(43) Pub. Date: Oct. 22, 2026

(54) METHOD AND SYSTEM FOR CONSTRUCTING DENSE POINT CLOUD MAP FOR HUMANOID ROBOT

(71) Applicant: SOOCHOW UNIVERSITY, Suzhou (CN)

(72) Inventors: Wenzheng CHI, Suzhou (CN); Shiyu MIAO, Suzhou (CN); Jiajie YU, Suzhou (CN); Chengfeng SUN, Suzhou (CN); Lining SUN, Suzhou (CN)

(21) Appl. No.: 19/432,969

(22) Filed: Dec. 25, 2025

Related U.S. Application Data
(63) Continuation of application No. PCT/CN2025/094504, filed on May 13, 2025.

(30) Foreign Application Priority Data
Apr. 18, 2025 (CN) 202510487629.1

(51) Int. Cl. G06T 7/73; G06T 7/246

(52) U.S. Cl. CPC G06T 7/74; G06T 7/248; G06T 2207/10016; G06T 2207/10028; G06T 2207/30244

(57) ABSTRACT

The invention provides a method and a system for constructing a dense point cloud map for a humanoid robot. The method includes: obtaining, in real time, a video image acquired during walking of the humanoid robot; determining a gait phase of the humanoid robot in a current frame image; estimating a camera pose of the current frame image based on the gait phase of the humanoid robot in the current frame image; determining whether the current frame image is a key frame based on the camera pose of the current frame image; and performing local mapping and loop closure detection by the key frame to obtain a global dense point cloud map. The invention effectively alleviates the blurring and jitter of the acquired data during mapping of the humanoid robot, such that a more accurate environmental map can be obtained, the precision of operational tasks of the robot is improved.

This application is a Continuation of PCT/CN2025/094504, filed on May 13, 2025, which claims priority to Chinese Patent Application No. 202510487629.1, filed on Apr. 18, 2025, which is incorporated by reference for all purposes as if fully set forth herein.

### FIELD OF THE INVENTION

The present disclosure relates to the technical field of point cloud map construction, and in particular, to a method and a system for constructing a dense point cloud map for a humanoid robot.

### DESCRIPTION OF THE RELATED ART

Currently in the labor market, the increasingly severe aging trend and the rapid rise in employee wages have become the primary drivers for robot-to-human substitution, fueling the rapid growth of domestic humanoid robot demand. Simultaneously, with the rapid advancement of technology, humanoid robots are progressively moving from laboratories to production lines, becoming the new favorite in smart manufacturing across various sectors such as education, catering, and logistics.

For a humanoid robot, simultaneous localization and mapping (SLAM) is a first step for implementing autonomous exploration and performing various tasks. The core idea of the SLAM algorithm is to use sensor data such as a laser radar and a camera of the robot in an environment to establish an environmental map in real time and calculate the position of the robot. The SLAM algorithm can be divided into two sub-problems: one is map building, and the other is robot localization. Compared with mobile robots, the human-like walking of the humanoid robot induces significant vertical motion and jolts that amplify the motion effect during the sensor acquisition process, which can easily lead to data blurring. Consequently, one of its quintessential tasks is to generate an accurate and high-fidelity environmental map.

At present, methods for optimizing mapping of a humanoid robot mainly include adjusting RGB frame tracking, camera pose tracking, multi-sensor fusion, and the like. For example, Oliver et al. successfully implemented a humanoid real-time 3D SLAM system for the first time. They demonstrated loop closure in an indoor environment using an HRP-2 robot by tightly coupling a pattern generator, robot odometry, and inertial sensing into a standard extended Kalman filter framework. Scona et al. proposed a method for tracking a camera pose that integrates Valkyrie humanoid motion information into an elastic fusion (EF) framework.

It combines frame-to-model visual tracking from elastic fusion with motion priors provided by a low-drift motion inertial state estimator, achieving local loop closure in micro-dynamic environments. Compared with the motion inertial state estimator and the vision tracking based on elastic fusion, the fusion method achieves a lower drift rate and higher mapping accuracy.

In an existing humanoid robot mapping method, visual mapping costs are lower, rich texture and color information can be obtained, and more accurate environment modeling is facilitated.

The RGB-D dense mapping method is a visual mapping method, which constructs a dense three-dimensional map for a scenario by using a color image and depth information that are obtained by an RGB-D sensor. During the mapping process, the oscillation of the center of mass of the humanoid robot caused by its human-like walking induces significant camera displacement, while the ground reaction force generated upon foot-ground impact also adversely affects image acquisition, leading to data blurring. Generally, the performance of current RGB-D dense mapping methods relies on smooth camera motion and well-textured scenarios. Consequently, for humanoid robots, both the accuracy and robustness of RGB-D dense mapping methods are reduced.

Currently, there are generally two types of strategies to improve the robustness and accuracy of RGB-D dense mapping. The first strategy is to compensate for the lack of visual information by integrating inertial information, thereby improving the performance of dense mapping during rapid motion or in textureless environments. However, since the drift error of the pose estimation is inevitable and increases over time, the performance of dense mapping will be affected by time. The second strategy is to design specialized optimization algorithms for the back-end of the dense mapping process to minimize drift errors. However, these optimization strategies are different for different scenarios, and it is still a challenging problem to improve the robustness and accuracy of dense mapping in general scenarios.

In summary, due to the human-like walking of the humanoid robot, the vertical motion and jolts caused thereby amplify the motion effect during the sensor acquisition process, and the shaking of the sensor blurs the acquired data, affecting the quality of map construction. This results in inaccurate localization of the humanoid robot, reduces the precision of its operational tasks, and also increases the risk of collisions during the traveling of the humanoid robot.

### SUMMARY OF THE INVENTION

Therefore, the technical problem to be solved by the present disclosure is to overcome the problem in the prior art that the quality of map construction is affected due to blurring of acquired data caused by shaking of a sensor during walking of a humanoid robot.

In order to solve the above technical problem, the present disclosure provides a method for constructing a dense point cloud map for a humanoid robot, which includes:
obtaining, in real time, a video image acquired during walking of the humanoid robot; determining a gait phase of the humanoid robot in a current frame image in the video image, including:
obtaining sensor information during the walking of the humanoid robot; dividing, according to the sensor information, a gait of the humanoid robot in the current frame image into a translational motion and a rotational motion by using a gait phase model, and clustering the translational motion and the rotational motion into a left/right-foot single-support phase and a double-support phase, separately;
estimating a camera pose of the current frame image based on the gait phase of the humanoid robot in the current frame image, including:
estimating, in a case that the gait phase is a left/right-foot single-support phase of the translational motion, the camera pose of the current frame image by using a constant velocity motion model;
estimating, in a case that the gait phase is a left/right-foot single-support phase of the rotational motion, the camera pose of the current frame image by using a brute-force matching model; and
determining, in a case that the gait phase is a double-support phase of the translational motion or a double-support phase of the rotational motion, a gait phase of the humanoid robot in a next frame image in the video image;
determining whether the current frame image is a key frame based on the camera pose of the current frame image; and
performing local mapping and loop closure detection by using the key frame to obtain a global dense point cloud map.

Preferably, the sensor information during the walking of the humanoid robot includes: IMU data, force-sensitive resistor data, and joint encoder data during the walking of the humanoid robot, where the IMU data during the walking of the humanoid robot includes IMU data of a center of mass of the humanoid robot and IMU data of two feet of the humanoid robot.

Preferably, the method further comprises preprocessing the sensor information after the sensor information is obtained during the walking of the humanoid robot, including:
performing smoothing processing on the sensor information by using a smooth function, and then performing dimensionality reduction by using a principal component analysis method.

Preferably, dividing, according to the sensor information, the gait of the humanoid robot in the current frame image into the translational motion and the rotational motion by using the gait phase model, and clustering the translational motion and the rotational motion into the left/right-foot single-support phase and the double-support phase, separately includes:
obtaining angular velocities of the center of mass in a z-axis direction according to the IMU data of the center of mass of the humanoid robot and the joint encoder data; calculating an average value and a standard deviation of the angular velocities of the center of mass in the z-axis direction within a time window, and inputting the average value and the standard deviation into a trained support vector machine, so as to divide the gait of the humanoid robot in the current frame image into the translational motion and the rotational motion; and
obtaining a vertical acceleration of the feet according to the IMU data of the two feet of the humanoid robot; obtaining a ground reaction force and a torque according to the force-sensitive resistor data; and clustering, based on the vertical acceleration of the feet and the ground reaction force and the torque, the translational motion and the rotational motion into the left/right-foot single-support phase and the double-support phase, separately by using a Gaussian mixture model.

Preferably, estimating, in the case that the gait phase is the left/right-foot single-support phase of the rotational motion, the camera pose of the current frame image by using the brute-force matching model includes:
extracting ORB feature points of the current frame image, and calculating descriptors of the ORB feature points of the current frame image as query descriptors;
obtaining ORB feature points of a previous frame image, and calculating descriptors of the ORB feature points of the previous frame image as matching descriptors;
for each query descriptor q, obtaining a matching descriptor a_{best} having a smallest Hamming distance therefrom as a matching result of a current query descriptor; and estimating the camera pose of the current frame image according to the matching result.

Preferably, after the matching descriptor a_{best} having the smallest Hamming distance from the query descriptor q is obtained as the matching result of the current query descriptor, Hamming distances between the matching descriptor a_{best} and all of the query descriptors are calculated; and in a case that the Hamming distance between the current query descriptor q and the matching descriptor a_{best} is also the smallest, the matching result is retained, and otherwise the matching result is discarded.

Preferably, after the matching result between the current query descriptor q and the matching descriptor a_{best} is retained, a matching descriptor a_{2nd} having a second-smallest Hamming distance from the current query descriptor q is obtained, a ratio of the Hamming distance d_{H}(q, a_{best}) between the current query descriptor q and the matching descriptor a_{best} to the Hamming distance d_{H}(q, a_{2nd}) between the current query descriptor q and the matching descriptor a_{2nd} is calculated, and a magnitude relationship between the ratio and a preset distance ratio is determined; and in a case that the ratio is less than the preset distance ratio, the matching result is retained, and otherwise the matching result is discarded.

Preferably, determining whether the current frame image is the key frame based on the camera pose of the current frame image includes:
determining the current frame image is the key frame in a case that a number of inliers in the current frame image exceeds a preset minimum inlier threshold and any one of the following conditions is satisfied; where a first condition is that a frame number difference between the current frame image and a previous key frame is greater than a preset maximum frame number; a second condition is that the frame number difference between the current frame image and the previous key frame is greater than a preset minimum frame number and a local mapping thread is in an idle state; and a third condition is that a number of key frames in a key frame queue in the local mapping thread does not exceed three.

Preferably, before determining whether the current frame image is the key frame based on the camera pose of the current frame image, the method further includes:
solving for a translation matrix and a rotation matrix between the current frame image and a previous frame image by constructing a least-squares problem, where the formula is expressed as follows:

$$arg min {\sum }_{i = 1}^{n} {‖ {x}_{t + 1}^{i} - ( R \cdot {x}_{t}^{i} + t ) ‖}^{2}$$

where xₜ₊₁ⁱ and xₜⁱ represent i-th ORB feature points of the current frame image and the previous frame image, respectively, n represents a total number of feature points, t represents a frame number index, R represents the rotation matrix, and t represents the translation matrix;
obtaining a transformation matrix

$$T = [ \begin{matrix}R & t \\ 0 & 1\end{matrix} ]$$

based on the translation matrix and the rotation matrix between the current frame image and the previous frame image; and
determining, in a case that a norm of the transformation matrix is less than a preset value, whether the current frame image is the key frame based on the camera pose of the current frame image.

The present disclosure further provides a system for constructing a dense point cloud map for a humanoid robot, which includes:
a video acquisition module, configured to obtain, in real time, a video image acquired during walking of the humanoid robot;
a gait determination module, configured to determine a gait phase of the humanoid robot in a current frame image in the video image, including: obtaining sensor information during the walking of the humanoid robot; dividing, according to the sensor information, a gait of the humanoid robot in the current frame image into a translational motion and a rotational motion by using a gait phase model, and clustering the translational motion and the rotational motion into a left/right-foot single-support phase and a double-support phase, separately;
a camera pose estimation module, configured to estimate a camera pose of the current frame image based on the gait phase of the humanoid robot in the current frame image, including: estimating, in a case that the gait phase is a left/right-foot single-support phase of the translational motion, the camera pose of the current frame image by using a constant velocity motion model; estimating, in a case that the gait phase is a left/right-foot single-support phase of the rotational motion, the camera pose of the current frame image by using a brute-force matching model; and otherwise, determining a gait phase of the humanoid robot in a next frame image in the video image;
a key frame determination module, configured to determine whether the current frame image is a key frame based on the camera pose of the current frame image; and
a map construction module, configured to perform local mapping and loop closure detection by using the key frame to obtain a global dense point cloud map.

Compared with the prior art, the above technical solutions of the present disclosure have the following beneficial effects.

According to the method for constructing a dense point cloud map for a humanoid robot in the present disclosure, on the basis of the original ORBSLAM2 algorithm, when a key frame is selected, a gait phase of the humanoid robot is first determined, and an image frame in a more stable left/right-foot single-support phase is selected for subsequent processing, such that a camera pose can be tracked more accurately despite the sensor jolts and jitter induced by the gait, the influence of gait on a camera is minimized, and a more stable image frame is obtained for subsequent processing. In addition, a camera pose of a current frame image is estimated by using a brute-force matching model with a large calculation amount only in a rotational motion with a large velocity change and severe camera shake, such that global information in an image can be fully used on the premise of consuming a small amount of computing resources, and an overall change relationship between images can be better captured. Therefore, a camera pose can be estimated more accurately, and the quality of point cloud map construction can be improved. The present disclosure effectively alleviates the blurring and jitter of the acquired data during mapping of the humanoid robot, such that a more accurate environmental map can be obtained, the precision of operational tasks of the robot is improved, and the risk of collisions during the traveling of the humanoid robot is reduced.

Further, in the present disclosure, the norm of a transformation matrix of two adjacent frame images is determined, and an image frame whose norm is less than a preset threshold is selected as a key frame. This avoids selecting an image frame with a relatively high degree of overlap and a relatively large impact of a gait as the key frame, thereby reducing a case of drift and overlap during mapping, and further improving the quality of a map constructed by the humanoid robot.

### BRIEF DESCRIPTION OF THE DRAWINGS

In order to facilitate a clear understanding of the contents of the present disclosure, the present disclosure will be further illustrated in detail below according to specific embodiments of the present disclosure in conjunction with the accompanying drawings. In the drawings:

FIG. 1 is a flowchart of a method for constructing a dense point cloud map for a humanoid robot according to the present disclosure;

FIG. 2 is diagrams of relationships between translational and rotational motions and a variance of Laplacian and a three-dimensional center-of-mass velocity, where (a) in FIG. 2 is a diagram of a relationship between the translational and rotational motions and the variance of Laplacian, and (b) in FIG. 2 is a diagram of a relationship between the translational and rotational motions and the three-dimensional center-of-mass velocity;

FIG. 3 is diagrams of relationships between a gait phase and a variance of Laplacian and a three-dimensional center-of-mass velocity, where (a) in FIG. 3 is a diagram of a relationship between the gait phase and the variance of Laplacian, and (b) in FIG. 3 is a diagram of a relationship between the gait phase and the three-dimensional center-of-mass velocity;

FIG. 4 is diagrams of relationships between a gait phase and a vertical ground reaction force and a vertical acceleration of feet, where (a) in FIG. 4 is a diagram of a relationship between the gait phase and the vertical ground reaction force of the feet, and (b) in FIG. 4 is a diagram of a relationship between the gait phase and a vertical acceleration of the feet; and

FIG. 5 is comparison diagrams of mapping effects before and after optimization according to the present disclosure, where line (a) in FIG. 5 is diagrams of the mapping effect before optimization, and line (b) in FIG. 5 is diagrams of the mapping effects after optimization.

### DETAILED DESCRIPTION OF THE PREFERRED EMBODIMENTS

The present disclosure will be further described below with reference to the accompanying drawings and specific examples, such that those skilled in the art can better understand and implement the present disclosure. However, the examples given should not be construed as limiting the present disclosure.

### Example 1

The ORBSLAM2 algorithm is an algorithm for constructing a dense point cloud map that is suitable for a wheeled robot. However, the wheeled robot moves smoothly while the camera shakes during the walking of the humanoid robot, so directly applying the ORBSLAM2 algorithm to the humanoid robot will cause the problem of low quality of the constructed map due to blurring of acquired data. Therefore, the present disclosure improves the ORBSLAM2 algorithm by analyzing the walking gait of the humanoid robot, such that the ORBSLAM2 algorithm is suitable for constructing a dense point cloud map for the humanoid robot.

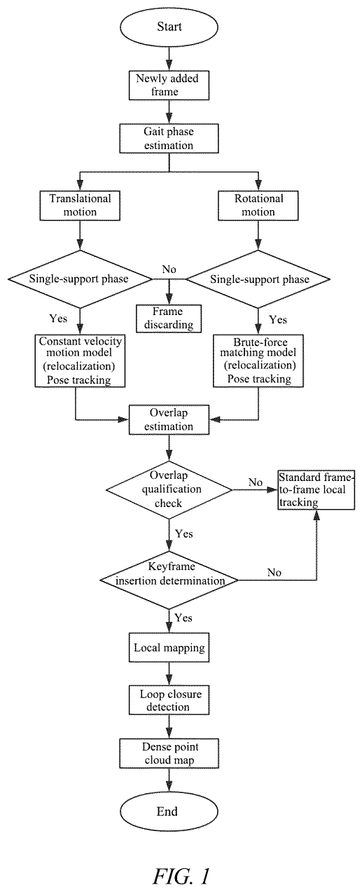

Referring to FIG. 1, the present disclosure provides a method for constructing a dense point cloud map for a humanoid robot, which includes:
S1, obtaining, in real time, a video image acquired during walking of the humanoid robot;
S2, determining a gait phase of the humanoid robot in a current frame image in the video image, including:
obtaining sensor information during the walking of the humanoid robot and preprocessing the sensor information; dividing, according to the preprocessed sensor information, a gait of the humanoid robot in the current frame image into a translational motion and a rotational motion by using a gait phase model, and clustering the translational motion and the rotational motion into a left/right-foot single-support phase and a double-support phase, separately;
S3, estimating a camera pose of the current frame image based on the gait phase of the humanoid robot in the current frame image, including:
estimating, in a case that the gait phase is a left/right-foot single-support phase of the translational motion, the camera pose of the current frame image by using a constant velocity motion model;
estimating, in a case that the gait phase is a left/right-foot single-support phase of the rotational motion, the camera pose of the current frame image by using a brute-force matching model; and
determining, in a case that the gait phase is a double-support phase of the translational motion or a double-support phase of the rotational motion, a gait phase of the humanoid robot in a next frame image in the video image;
S4, determining whether the current frame image is a key frame based on the camera pose of the current frame image; and if not, returning to determine a gait phase of the humanoid robot in a next frame image in the video image; and
S5, performing local mapping and loop closure detection by using the key frame to obtain a global dense point cloud map.

A scenario used for simulation in this example is an indoor closed scenario, and a wall, an obstacle, and the like are added and visualized by using simulation software vrep.

A color image frame and a depth image frame need to be acquired from the video image of S1.

In this example, during walking of the humanoid robot, a head-mounted camera acquires a depth image and a color image, and records the depth image and the color image by using a rosbag tool.

S2 is used for predicting a gait phase of the humanoid robot in real time during walking. To optimize the mapping process of the humanoid robot, the present disclosure establishes a gait phase model of the humanoid robot, uses the gait phase model to identify the gait phase during the walking process of the humanoid robot, and performs mapping optimization based on different gait phases, so as to minimize external motion interference caused by walking.

Designing the gait phase model of the humanoid robot includes the following steps.

In S21, in order to design a gait phase model, the present disclosure first studies center-of-mass dynamics of the humanoid robot during walking. These dynamics are described by Newton-Euler equations:

$$m ( \ddot{c} + g ) = {\sum }_{i} {f}_{k}$$

$$mc \times ( \ddot{c} + g ) + \dot{L} = {\sum }_{i} {s}_{k} \times {f}_{k} + {τ}_{k}$$

where c and \ddot{c} represent the position and acceleration of the center of mass, respectively, \dot{L} represents a rate of angular momentum around the center of mass, fₖ and τₖ represent a ground reaction force and a torque at the k-th contact point, sₖ represents the k-th contact point between the robot and the ground, g represents a gravity vector, and m represents the mass of the robot.

In S22, it can be seen from the center-of-mass dynamics that the key indicators of the gait phase of the robot are the position and acceleration of the center of mass, and the ground reaction force and torque, so the sensor information acquired by the present disclosure during the walking of the humanoid robot includes: IMU data, force-sensitive resistor data, and joint encoder data during the walking of the humanoid robot, where the IMU data during the walking of the humanoid robot includes IMU data of the center of mass of the humanoid robot and IMU data of two feet of the humanoid robot. The vertical acceleration of the center of mass and the angular velocity of the center of mass in the z-axis direction are obtained according to the IMU data of the center of mass of the robot and the joint encoder data; the vertical acceleration of the feet is obtained according to the IMU data of the two feet of the robot; and the ground reaction force and torque are obtained according to the force-sensitive resistor data.

In this example, in a VREP simulation environment in an ROS system, a humanoid robot is controlled to walk, and a rosbag tool is used to record, in real time, IMU data, force-sensitive resistor data, and joint encoder data that are acquired during the walking of the humanoid robot.

In this example, reading the data information in a bag file and preprocessing the acquired sensor information of the humanoid robot during walking include:
performing smoothing processing on the sensor information by using a smooth function, and filtering out data that exhibits abrupt changes caused by the robot's instability-induced swaying in the forward-backward and lateral directions; and
then performing dimensionality reduction by using a principal component analysis method, and mapping the data to a two-dimensional space, thus effectively capturing the underlying dynamic information.

In S23, the gait phase model is constructed based on the preprocessed sensor information to perform gait phase estimation. The gait phase model includes a support vector machine and a Gaussian mixture model, where the support vector machine is configured to first divide the gait of the humanoid robot into a rotational motion and a translational motion during walking, and the Gaussian mixture model is configured to further divide the gait phase into a left/right-foot single-support phase and a double-support phase. The step specifically includes the following steps.

In S231, first, preliminary classification is performed on the gait by using the acquired angular velocities of the center of mass in the z-axis direction, and an average value and a standard deviation of the angular velocities of the center of mass in the z-axis direction within the time window are calculated:

$$\overline{{ω}_{Z}} = \frac{1}{N} {\sum }_{t = 1}^{N} {ω}_{Z} ( t )$$

$${σ}_{{ω}_{Z}} = \sqrt{\frac{1}{N} {\sum }_{t = 1}^{N} {( {ω}_{Z} ( t ) - \overline{{ω}_{Z}} )}^{2}}$$

where ω_{Z}(t) represents an angular velocity at a moment t, N represents the amount of data within the time window, and ω̅_̅{̅Z̅}̅ and σ_{ω}_{_{Z}} represent the average value and the standard deviation of the angular velocities, respectively.

In the training phase, a threshold is set for the average value and the standard deviation of the angular velocities, and the threshold is used as an input of the support vector machine. The rotational motion and the translational motion are respectively used as different labels as outputs, and the gait is successfully divided into the rotational motion and the translational motion through learning.

In the inference phase, the average value and the standard deviation of the angular velocities of the center of mass in the z-axis direction within the time window are input into the trained support vector machine, and the gait of the humanoid robot in the current frame is divided into the translational motion and the rotational motion.

In S232, after the gait of the humanoid robot in the current frame is divided into the translational motion and the rotational motion by using the support vector machine, the rotational motion and the translational motion are separately clustered by using a Gaussian mixture model, with each cluster outputting three sets of data. The Gaussian mixture model clusters the translational motion and the rotational motion into a left/right-foot single-support phase and a double-support phase, separately, by fitting a Gaussian distribution for each cluster and classifying according to the probability of each data point.

Through the gait phase model, the gait of the humanoid robot is divided into a left/right-foot single-support phase of a translational motion, a double-support phase of a translational motion, a left/right-foot single-support phase of a rotational motion, and a double-support phase of a rotational motion.

The present disclosure analyzes the phases of motion rules and irregularities during the walking of the robot based on the obtained different gait phases, and designs a mapping optimization method.

In S3, in order to evaluate the influence of the rotational motion and the translational motion on the obtained image frame, the present disclosure uses the variance of Laplacian for evaluation. The variance of Laplacian evaluates the definition of an image by calculating the degree of grayscale change in the image. First, a color image is converted into a grayscale image:

gray=0.2989R+0.5870G+0.1140B

where R, G, and B represent pixel values of red, green, and blue channels of the image, respectively, and gray represents a grayscale value of the image.

The Laplacian operator kernel is convolved with the image to obtain a Laplacian transformation result of the image, which captures a region with a grayscale change in the image, and a variance is calculated:

$${S}^{2} = \frac{1}{{N}^{′}} {\sum }_{u = 1}^{{N}^{′}} {( {L}_{u} - μ )}^{2}$$

where S² represents the variance of the Laplacian values, Lᵤ represents the apian value of the u-th pixel in the image, μ represents the average value of all the Laplacian values, and N′ represents the total number of pixels in the image.

The larger the calculated variance is, the more obvious the edges of the image are, and the clearer the image is; the smaller the calculated variance is, the more gentle the edges of the image are, the less obvious the edges or details are, and the more blurred the image is. Through calculation and comparison, it is found in the present disclosure that blurring is more likely to occur in a rotational motion image than in a translational motion image.

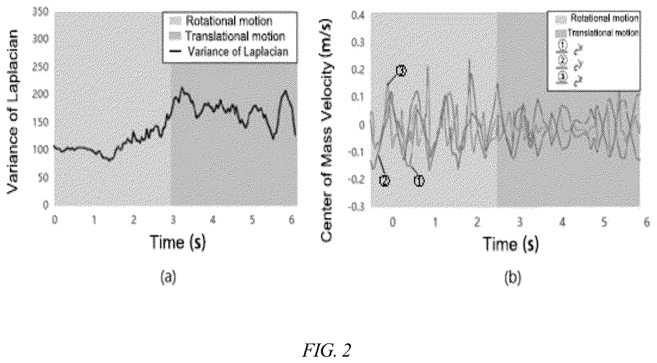

In order to evaluate the influence of the rotational motion and the translational motion on the camera motion velocity, the present disclosure evaluates the three-dimensional center-of-mass velocity estimated by using a state estimation robot walking (SEROW) framework. The robot walking framework calculates a center-of-mass velocity by using previously obtained sensor information. It is found through comparison that a center-of-mass velocity of a rotational motion usually fluctuates greatly and is unstable compared with that of a translational motion. Specifically, referring to FIG. 2, (a) in FIG. 2 is a diagram of a relationship between the translational and rotational motions and the variance of Laplacian, where the curve represents the variance of the Laplacian determinant; (b) in FIG. 2 is a diagram of a relationship between the translational and rotational motions and the three-dimensional center-of-mass velocity, where lines labeled as \textcircled{1}, \textcircled{2} and \textcircled{3} represent center-of-mass velocities on the x, y and z axes, respectively. It can be seen from FIG. 2 that the variance of Laplacian during the rotational motion is consistently lower than that during the translational motion. Consequently, images are more prone to blurring during the rotational motion compared to the translational motion.

Furthermore, the rotational motion typically exhibits greater fluctuations and instability in the center-of-mass velocity than the translational motion.

In order to evaluate the influence of each gait phase on the obtained image frame, the variance of Laplacian and the three-dimensional center-of-mass velocity are also used for evaluation.

By comparison, it is found that most peaks in the diagram of the variance of Laplacian are located within the left/right-foot single-support phases, and the image definition is high. At the same time, most zero-crossings of the three-dimensional center-of-mass velocity occur at the beginning of the left- and right-foot single-support phase. At this instant, the minimal motion is transferred to the camera, providing an ideal opportunity for capturing high-quality images.

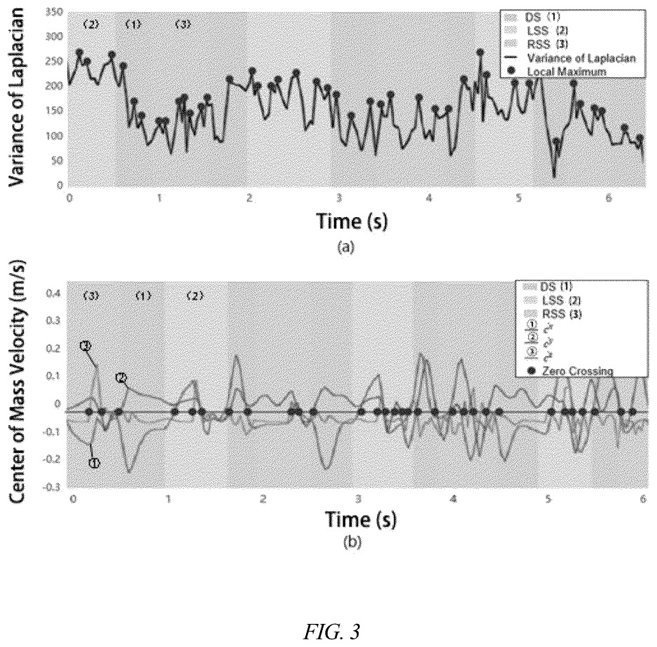

Specifically, referring to FIG. 3, (a) in FIG. 3 is a diagram of a relationship between the gait phase and the variance of Laplacian, where the curve represents the variance of the Laplacian determinant, and points represent local maximum values; and (b) in FIG. 3 is a diagram of a relationship between the gait phase and the three-dimensional center-of-mass velocity, where lines labeled as \textcircled{1}, \textcircled{2}, and \textcircled{3} represent center-of-mass velocities on the x, y and z axes, respectively, points are corresponding zero-crossing points, and regions labeled as (1), (2), and (3) represent a double-support phase, a left-foot single-support phase, and a right-foot single-support phase, respectively. It can be seen from FIG. 3 that most peaks in the diagram of variance of Laplacian are located within the left/right-foot single-support phases, and in this case, the image definition is high. Most zero-crossings of the three-dimensional center-of-mass velocity occur at the beginning of the left- and right-foot single-support phases. At this instant, the minimal motion is transferred to the camera, and the image quality is high.

In addition, the present disclosure further compares the influence of each gait phase on the obtained image frame based on the sensor data. It can be seen from the vertical accelerations of the left and right feet that the impact acceleration of each leg stabilizes and approaches zero shortly after the left/right-foot single-support phases, with minimal transmission to the image frames of the robot. Similarly, upon entering the left/right-foot single-support phase, the ground reaction forces under the two feet stabilize. Consequently, the image frames obtained during the left/right-foot single-support phases are clearer and more stable.

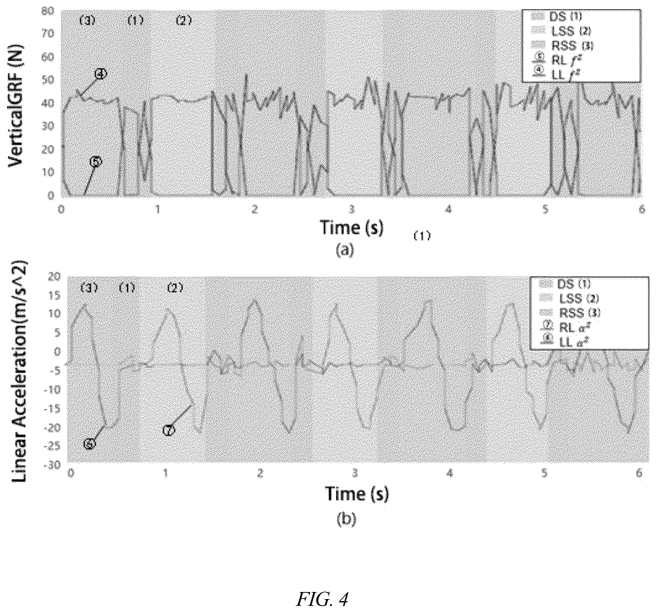

Specifically, referring to FIG. 4, (a) in FIG. 4 is a diagram of a relationship between a gait phase and a vertical ground reaction force of a foot during walking of the humanoid robot, where lines labeled as (4) and (5) represent ground reaction forces of left and right feet, respectively; and (b) in FIG. 4 is a diagram of a relationship between the gait phase and a vertical acceleration of a foot, where lines labeled as \textcircled{6} and \textcircled{7} represent vertical accelerations of left and right feet, respectively. It can be seen from FIG. 4 that the impact acceleration of each foot stabilizes and approaches zero shortly after the left/right-foot single-support phases, with minimal transmission to the image frames of the robot. Similarly, upon entering the left/right-foot single-support phase, the ground reaction forces under the two feet stabilize.

Consequently, the image frames obtained during the left/right-foot single-support phases are clearer and more stable.

Therefore, the present disclosure concludes through comparison that the rotational motion exhibits greater velocity instability and is more prone to image blurring than the translational motion. The original pose estimation module in ORBSLAM2 employs a constant velocity motion model, and the core idea is as follows: It is assumed that an object in a short time (adjacent frames) is in a uniform-velocity motion state. However, for humanoid robots, irregular velocity change induced by the gait and severe camera shake during the rotational motion often cause this motion model to fail in providing reliable pose estimates. However, the brute-force matching model has disadvantages such as a large calculation amount and poor scalability, and therefore, the brute-force matching model is used only in a rotational motion with a large velocity change and severe camera shake.

Since the images in the left/right-foot single-support phase are more stable and minimally affected by gait through comparison, the gait phase in the left/right-foot single-support phase is selected as the key frame in the mapping, and the stable key frame is selected through the translation and rotation changes between the image frames.

Specifically, the constant velocity motion model is tracking matching, that is, map points are projected to a current frame for matching, and then optimization is performed according to bundle adjustment (BA), which is equivalent to classic perspective-n-point (PnP).

The following specifically describes a case in which the camera pose of the current frame image is estimated by using the brute-force matching model under a condition that the gait phase is a left/right-foot single-support phase of the rotational motion, which includes the following steps.

In S31, ORB feature points of the current frame image are extracted, and descriptors of the ORB feature points of the current frame image are calculated as query descriptors; and ORB feature points of the previous frame image are obtained, and descriptors of the ORB feature points of the previous frame image are calculated as matching descriptors.

It is assumed that Iₜ and Iₜ₊₁ represent the previous frame image and the current frame image, respectively, the feature points extracted from the current frame image Iₜ₊₁ represent

$${x}_{t + 1}^{, i} i = 1 , 2 , … , n ,$$

the feature points extracted from the previous frame image Iₜ represent

$${x}_{t}^{i} , i = 1 , 2 , … , n ,$$

and n represents the total number of the feature points.

A descriptor of each feature point is calculated, where descriptors

$${q}_{t + 1}^{j} , j = 1 , 2 , … , m$$

of the feature points of the current frame image Iₜ₊₁ represent query descriptors, descriptors

$${a}_{t + 1}^{j} , j = 1 , 2 , … , m$$

of the feature points of the previous frame image Iₜ represent matching descriptors, and m represents the total number of descriptors. The descriptors of each frame image are matched with those of the previous frame image, and in the case that the matching is successful, the initial camera pose is estimated.

In S32, for each query descriptor q, a matching descriptor a_{best} having the smallest Hamming distance therefrom is obtained as a matching result of a current query descriptor.

For each query descriptor of the current frame Iₜ₊₁, the most similar descriptor is found by calculating the Hamming distance from the matching descriptor in the previous frame Iₜ, and the calculation formula is expressed as follows:

$${d}_{H} ( q , a ) = {\sum }_{v = 1}^{{n}^{′}} {1}_{{q}_{v} \neq {a}_{v}}$$

where qᵥ and aᵥ represent the values at the v-th position of the query descriptor q and the matching descriptor a, respectively, and n′ represents the total length of the descriptors.

For each query descriptor q, the Hamming distances d_{H}(q, aⱼ) from all matching descriptors aⱼ of the previous frame are calculated, and the descriptor a_{best} with the smallest distance is selected as the matching result:

$${a}_{best} = {arg min}_{{a}_{j}} {d}_{H} ( q , {a}_{j} )$$

In S33, in order to ensure the matching quality, a mutual best-match condition is applied. A match between q and a_{best} is considered valid if and only if a_{best} represents the best matching feature of q in the previous frame image, and q represents the best matching feature of a_{best} in the current frame image.

After the matching descriptor a_{best} having the smallest Hamming distance from the query descriptor q is obtained as the matching result of the current query descriptor, Hamming distances between the matching descriptor a_{best} and all of the query descriptors are calculated; and in a case that the Hamming distance between the current query descriptor q and the matching descriptor a_{best} is also the smallest, the matching result is retained, and otherwise the matching result is discarded.

In S34, in order to further improve the matching reliability, after the matching result between the current query descriptor q and the matching descriptor a_{best} is retained, a matching descriptor a_{2nd} having the second-smallest Hamming distance from the current query descriptor q is obtained, the ratio of the Hamming distance d_{H}(q, a_{best}) between the current query descriptor q and the matching descriptor a_{best} to the Hamming distance d_{H}(q, a_{2nd}) between the current query descriptor q and the matching descriptor a_{2nd} is calculated, and a magnitude relationship between the ratio and a preset distance ratio r is determined, where the formula is expressed as follows:

$$\frac{{d}_{H} ( q , {a}_{best} )}{{d}_{H} ( q , {a}_{2 nd} )} < r$$

In the case that the ratio is less than the preset distance ratio, the matching result is retained, and otherwise, the matching result is discarded.

In S35, the initial camera pose of the current frame image is estimated according to the matching result.

This approach improves the quality and reliability of the match with rotation and jitter, thus reducing the chance of tracking failure.

In S36, the local map is tracked according to the estimated initial pose, the calculation is further performed, and the initial camera pose is optimized according to a bundle adjustment method.

In the case that the camera pose estimation is reliable, ORBSLAM2 selects a key frame for joining through S4.

In S4, determining whether the current frame image is the key frame based on the camera pose of the current frame image includes: The number of inliers in the current frame image exceeds a preset minimum inlier threshold and any one of the following conditions is satisfied:
(1) a frame number difference between the current frame image and a previous key frame is greater than a preset maximum frame number;
(2) the frame number difference between the current frame image and the previous key frame is greater than a preset minimum frame number and a local mapping thread is in an idle state; and
(3) the number of key frames in a key frame queue in the local mapping thread does not exceed three.

The inliers refer to the feature points in the current frame image that are successfully matched with those in the previous frame image, and are obtained based on the camera pose of the current frame image.

Due to the significant translation and rotation between image frames caused by camera shake from the gait of the humanoid robot during walking, the present disclosure adds a relative motion criterion to the original key frame selection conditions of ORBSLAM2. This is achieved by evaluating the overlapping degree of two adjacent frame images to obtain a stable key frame.

Preferably, before determining whether the current frame image is the key frame based on the camera pose of the current frame image, the method further includes:
solving for a translation matrix and a rotation matrix between the current frame image and a previous frame image by constructing a least-squares problem, where the formula is expressed as follows:

$$arg min {\sum }_{i = 1}^{n} {‖ {x}_{t + 1}^{i} - ( R \cdot {x}_{t}^{i} + t ) ‖}^{2}$$

where

$${x}_{t + 1}^{i}$$

and

$${x}_{t}^{i}$$

represent the i-th ORB feature points of the current frame image and the previous frame image, respectively, n represents a total number of feature points, t represents a frame number index, R represents the rotation matrix, and t represents the translation matrix;

In order to simplify the problem, by subtracting the center of mass of each feature point from its position, new feature points

$${x}_{t + 1}^{{i}^{′}}$$

and

$${x}_{t}^{{i}^{′}}$$

of the current frame image and the previous frame image are obtained, the influence caused by translation is eliminated, and only the position change of the rotation is retained:

$$R arg min {\sum }_{i = 1}^{n} {‖ {x}_{t + 1}^{{i}^{′}} - R \cdot {x}_{t}^{{i}^{′}} ‖}^{2}$$

The above formula is extended and simplified:

$$R arg min {\sum }_{i = 1}^{n} - {x}_{t + 1}^{{i}^{′ T}} R {x}_{t}^{{i}^{′}} = arg min ( - t r ( R {\sum }_{i = 1}^{n} {x}_{t + 1}^{{i}^{′ T}} {x}_{t}^{{i}^{′}} ) )$$

SVD decomposition is performed on the summation term in the formula, and the rotation matrix R is determined in the case that the summation term matrix is of full rank. A translation matrix t is then solved for using the calculated R:

$$t = {x}_{t + 1}^{i} - R {x}_{t}^{i}$$

A transformation matrix

$$T = [ \begin{matrix}R & t \\ 0 & 1\end{matrix} ]$$

is obtained based on the translation matrix and the rotation matrix between the current frame image and the previous frame image.

In the case that the norm of the transformation matrix is less than a preset value, whether the current frame image is the key frame is determined based on the camera pose of the current frame image. In the case that the translation and rotation matrices are small, it indicates that the overlapping degree of two adjacent frame images is small, the influence of the gait is small, and the image is stable.

S5 is specifically as follows:

A local map is constructed by taking the current key frame as a center. The feature points matched with the current key frame are added to the local map, and the spatial relationship between the feature points is calculated based on the camera pose and the three-dimensional coordinates of the feature points, so as to construct the topological structure of the local map.

The local maps are connected through loop closure detection and global optimization, so as to construct the global map. The global map is a sparse map composed of multiple key frames and the feature points corresponding thereto, which can reflect the general structure of the entire scenario and the motion trajectory of the camera.

For image frames of non-key frames, standard frame-to-frame local tracking is performed.

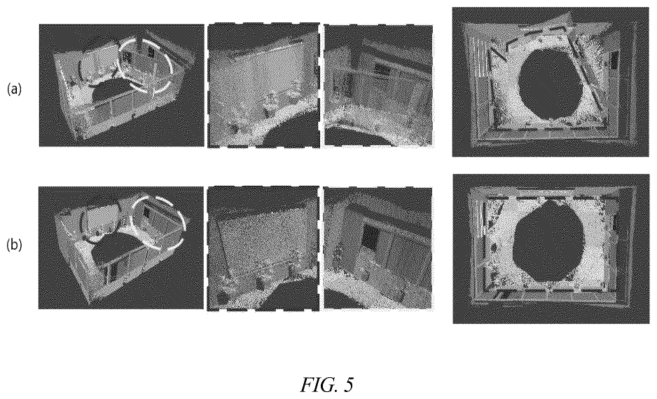

FIG. 5 is comparison diagrams of mapping effects before and after optimization, where line (a) in FIG. 5 is diagrams of the mapping effect before optimization, and line (b) in FIG. 5 is diagrams of the mapping effects after optimization. It can be seen from FIG. 5 that the optimization results of the present disclosure lead to improvements in loop closure detection, drift mitigation, and overlap handling during mapping for the humanoid robot.

In conclusion, according to the method for constructing a dense point cloud map for a humanoid robot in the present disclosure, on the basis of the original ORBSLAM2 algorithm, when a key frame is selected, a gait phase of the humanoid robot is first determined, and an image frame in a more stable left/right-foot single-support phase is selected for subsequent processing, such that a camera pose can be tracked more accurately despite the sensor jolts and jitter induced by the gait, the influence of the gait on a camera is minimized, and a more stable image frame is obtained for subsequent processing. In addition, a camera pose of a current frame image is estimated by using a brute-force matching model with a large calculation amount only in a rotational motion with a large velocity change and severe camera shake, such that global information in an image can be fully used on the premise of consuming a small amount of computing resources, and an overall change relationship between images can be better captured.

Therefore, a camera pose can be estimated more accurately, and the quality of point cloud map construction can be improved. The present disclosure effectively alleviates the blurring and jitter of the acquired data during mapping of the humanoid robot, such that a more accurate environmental map can be obtained, the precision of operational tasks of the robot is improved, and the risk of collisions during the traveling of the humanoid robot is reduced.

Further, in the present disclosure, the norm of a transformation matrix of two adjacent frame images is determined, and an image frame whose norm is less than a preset threshold is selected as a key frame. This avoids selecting an image frame with a relatively high degree of overlap and a relatively large impact of a gait as the key frame, thereby reducing a case of drift and overlap during mapping, and further improving the quality of a map constructed by the humanoid robot.

### Example 2

Based on the method for constructing a dense point cloud map for a humanoid robot described in Example 1, this example further provides a system for constructing a dense point cloud map for a humanoid robot, which includes:
a video acquisition module, configured to obtain, in real time, a video image acquired during walking of the humanoid robot;
a gait determination module, configured to determine a gait phase of the humanoid robot in a current frame image in the video image, including: obtaining sensor information during the walking of the humanoid robot; dividing, according to the sensor information, a gait of the humanoid robot in the current frame image into a translational motion and a rotational motion by using a gait phase model, and clustering the translational motion and the rotational motion into a left/right-foot single-support phase and a double-support phase, separately;
a camera pose estimation module, configured to estimate a camera pose of the current frame image based on the gait phase of the humanoid robot in the current frame image, including: estimating, in a case that the gait phase is a left/right-foot single-support phase of the translational motion, the camera pose of the current frame image by using a constant velocity motion model; estimating, in a case that the gait phase is a left/right-foot single-support phase of the rotational motion, the camera pose of the current frame image by using a brute-force matching model; and otherwise, determining a gait phase of the humanoid robot in a next frame image in the video image;
a key frame determination module, configured to determine whether the current frame image is a key frame based on the camera pose of the current frame image; and
a map construction module, configured to perform local mapping and loop closure detection by using the key frame to obtain a global dense point cloud map.

Those skilled in the art should appreciate that the embodiments of the present application may be provided as a method, a system, or a computer program product. Accordingly, the present application may take the form of an entire hardware embodiment, an entire software embodiment, or an embodiment combining software and hardware aspects. Furthermore, the present application may take the form of a computer program product implemented on one or more computer-available storage media (including, but not limited to, a disk memory, a CD-ROM, an optical memory, and the like) containing computer-available program codes therein.

The present application is described with reference to flowcharts and/or block diagrams of the method, the device (system), and the computer program product according to the embodiments of the present application. It should be understood that each flow and/or block in the flowcharts and/or the block diagrams and a combination of the flows and/or the blocks in the flowcharts and/or the block diagrams may be implemented by computer program instructions. These computer program instructions may be provided for a general-purpose computer, a special-purpose computer, an embedded processor, or processors of other programmable data processing devices to generate a machine, such that an apparatus for achieving functions designated in one or more flows of the flowcharts and/or one or more blocks of the block diagrams is generated based on instructions executed by the computers or the processors of the other programmable data processing devices.

These computer program instructions may also be stored in a computer-readable memory capable of guiding the computers or the other programmable data processing devices to operate in a specific mode, such that a manufactured product including an instruction apparatus is generated based on the instructions stored in the computer-readable memory, and the instruction apparatus achieves the functions designated in one or more flows of the flowcharts and/or one or more blocks of the block diagrams.

These computer program instructions may also be loaded onto the computers or the other programmable data processing devices, such that processing implemented by the computers is generated by executing a series of operation steps on the computers or the other programmable devices, and therefore the instructions executed on the computers or the other programmable devices provide a step of achieving the functions designated in one or more flows of the flowcharts and/or one or more blocks of the block diagrams.

It is obvious that the above embodiments are merely examples for clear illustration and are not intended to limit implementations. Various changes and modifications can be made by those of ordinary skill in the art on the basis of the above description. It is unnecessary and impossible to exhaust all the embodiments herein. Obvious changes or modifications derived therefrom still fall within the protection scope of the present disclosure.

What is claimed is:

1. A method for constructing a dense point cloud map for a humanoid robot, comprising:
obtaining, in real time, a video image acquired during walking of the humanoid robot;
determining a gait phase of the humanoid robot in a current frame image in the video image, comprising:
obtaining sensor information during the walking of the humanoid robot; dividing, according to the sensor information, a gait of the humanoid robot in the current frame image into a translational motion and a rotational motion by using a gait phase model, and clustering the translational motion and the rotational motion into a left/right-foot single-support phase and a double-support phase, separately;
estimating a camera pose of the current frame image based on the gait phase of the humanoid robot in the current frame image, comprising:
estimating, in a case that the gait phase is a left/right-foot single-support phase of the translational motion, the camera pose of the current frame image by using a constant velocity motion model;
estimating, in a case that the gait phase is a left/right-foot single-support phase of the rotational motion, the camera pose of the current frame image by using a brute-force matching model; and
determining, in a case that the gait phase is a double-support phase of the translational motion or a double-support phase of the rotational motion, a gait phase of the humanoid robot in a next frame image in the video image;
determining whether the current frame image is a key frame based on the camera pose of the current frame image; and
performing local mapping and loop closure detection by using the key frame to obtain a global dense point cloud map.

2. The method for constructing a dense point cloud map for a humanoid robot according to claim 1, wherein the sensor information during the walking of the humanoid robot comprises: IMU data, force-sensitive resistor data, and joint encoder data during the walking of the humanoid robot, wherein the IMU data during the walking of the humanoid robot comprises IMU data of a center of mass of the humanoid robot and IMU data of two feet of the humanoid robot.

3. The method for constructing a dense point cloud map for a humanoid robot according to claim 2, further comprising preprocessing the sensor information after the sensor information is obtained during the walking of the humanoid robot, comprising:
performing smoothing processing on the sensor information by using a smooth function, and then performing dimensionality reduction by using a principal component analysis method.

4. The method for constructing a dense point cloud map for a humanoid robot according to claim 2, wherein dividing, according to the sensor information, the gait of the humanoid robot in the current frame image into the translational motion and the rotational motion by using the gait phase model, and clustering the translational motion and the rotational motion into the left/right-foot single-support phase and the double-support phase, separately comprises:
obtaining angular velocities of the center of mass in a z-axis direction according to the IMU data of the center of mass of the humanoid robot and the joint encoder data; calculating an average value and a standard deviation of the angular velocities of the center of mass in the z-axis direction within a time window, and inputting the average value and the standard deviation into a trained support vector machine, to divide the gait of the humanoid robot in the current frame image into the translational motion and the rotational motion; and
obtaining a vertical acceleration of the feet according to the IMU data of the two feet of the humanoid robot; obtaining a ground reaction force and a torque according to the force-sensitive resistor data; and clustering, based on the vertical acceleration of the feet and the ground reaction force and the torque, the translational motion and the rotational motion into the left/right-foot single-support phase and the double-support phase, separately by using a Gaussian mixture model.

5. The method for constructing a dense point cloud map for a humanoid robot according to claim 1, wherein estimating, in the case that the gait phase is the left/right-foot single-support phase of the rotational motion, the camera pose of the current frame image by using the brute-force matching model comprises:
extracting ORB feature points of the current frame image, and calculating descriptors of the ORB feature points of the current frame image as query descriptors;
obtaining ORB feature points of a previous frame image, and calculating descriptors of the ORB feature points of the previous frame image as matching descriptors;
for each query descriptor q, obtaining a matching descriptor a_{best} having a smallest Hamming distance therefrom as a matching result of a current query descriptor; and
estimating the camera pose of the current frame image according to the matching result.

6. The method for constructing a dense point cloud map for a humanoid robot according to claim 5, wherein after the matching descriptor a_{best} having the smallest Hamming distance from the query descriptor q is obtained as the matching result of the current query descriptor, Hamming distances between the matching descriptor a_{best} and all of the query descriptors are calculated; and in a case that the Hamming distance between the current query descriptor q and the matching descriptor a_{best} is also the smallest, the matching result is retained, and otherwise the matching result is discarded.

7. The method for constructing a dense point cloud map for a humanoid robot according to claim 6, wherein after the matching result between the current query descriptor q and the matching descriptor a_{best} is retained, a matching descriptor a_{2nd} having a second-smallest Hamming distance from the current query descriptor q is obtained, a ratio of the Hamming distance d_{H} (q, a_{best}) between the current query descriptor q and the matching descriptor a_{best} to the Hamming distance d_{H}(q, a_{2nd}) between the current query descriptor q and the matching descriptor a_{2nd} is calculated, and a magnitude relationship between the ratio and a preset distance ratio is determined; and in a case that the ratio is less than the preset distance ratio, the matching result is retained, and otherwise the matching result is discarded.

8. The method for constructing a dense point cloud map for a humanoid robot according to claim 1, wherein determining whether the current frame image is the key frame based on the camera pose of the current frame image comprises:
determining the current frame image is the key frame in a case that a number of inliers in the current frame image exceeds a preset minimum inlier threshold and any one of a first condition, a second condition and a third condition is satisfied; wherein a first condition is that a frame number difference between the current frame image and a previous key frame is greater than a preset maximum frame number; a second condition is that the frame number difference between the current frame image and the previous key frame is greater than a preset minimum frame number and a local mapping thread is in an idle state; and a third condition is that a number of key frames in a key frame queue in the local mapping thread does not exceed three.

9. The method for constructing a dense point cloud map for a humanoid robot according to claim 8, wherein before determining whether the current frame image is the key frame based on the camera pose of the current frame image, the method further comprises:
solving for a translation matrix and a rotation matrix between the current frame image and a previous frame image by constructing a least-squares problem, wherein a formula is expressed as follows:
$$arg min {\sum }_{i = 1}^{n} {‖ {x}_{t + 1}^{i} - ( R \cdot {x}_{t}^{i} + t ) ‖}^{2}$$
wherein
$${x}_{t + 1}^{i}$$
and
$${x}_{t}^{i}$$
represent i-th ORB feature points of the current frame image and the previous frame image, respectively, n represents a total number of feature points, t represents a frame number index, R represents the rotation matrix, and t represents the translation matrix;
obtaining a transformation matrix
$$T = [ \begin{matrix}R & t \\ 0 & 1\end{matrix} ]$$
based on the translation matrix and the rotation matrix between the current frame image and the previous frame image; and
determining, in a case that a norm of the transformation matrix is less than a preset value, whether the current frame image is the key frame based on the camera pose of the current frame image.

10. A system for constructing a dense point cloud map for a humanoid robot, comprising:
a video acquisition module, configured to obtain, in real time, a video image acquired during walking of the humanoid robot;
a gait determination module, configured to determine a gait phase of the humanoid robot in a current frame image in the video image, comprising: obtaining sensor information during the walking of the humanoid robot; dividing, according to the sensor information, a gait of the humanoid robot in the current frame image into a translational motion and a rotational motion by using a gait phase model, and clustering the translational motion and the rotational motion into a left/right-foot single-support phase and a double-support phase, separately;
a camera pose estimation module, configured to estimate a camera pose of the current frame image based on the gait phase of the humanoid robot in the current frame image, comprising: estimating, in a case that the gait phase is a left/right-foot single-support phase of the translational motion, the camera pose of the current frame image by using a constant velocity motion model; estimating, in a case that the gait phase is a left/right-foot single-support phase of the rotational motion, the camera pose of the current frame image by using a brute-force matching model; and otherwise, determining a gait phase of the humanoid robot in a next frame image in the video image;
a key frame determination module, configured to determine whether the current frame image is a key frame based on the camera pose of the current frame image; and
a map construction module, configured to perform local mapping and loop closure detection by using the key frame to obtain a global dense point cloud map.
